(19) United States
(12) Patent Application Publication
(10) Pub. No.: US 2009/0175679 A1
(43) Pub. Date: Jul. 9, 2009

(54) Joint configuration for metal tubes

(75) Inventors: Chris Brandel, Chicago, IL (US); John Jaqua, LaPorte, IN (US)

Correspondence Address: Anderson Gorecki & Manaras, LLP;Attn: John C. Gorecki, P.O BOX 553, CARLISLE, MA, 01741, US

(73) Assignee: Bretford Manufacturing, Inc., Franklin Park, IL (US)

(21) Appl. No.: 12/006,514

(22) Filed: Jan. 3, 2008

(51) Int. Cl. F16L 11/14

(52) U.S. Cl. 403/346; 285/54

(57) ABSTRACT

A joint between two metal tubes may be formed by creating a cutout on each of the tubes, each cutout having a pair of channels sized according to a wall thickness of a tube to be received, and then pressing the tubes together. Teeth are formed in the channels to engage the wall of the opposite tube when the tubes are pressed together to prevent the joint from separating once created. Optionally a mechanical fastener may be used to further strengthen the joint structure.

### BACKGROUND OF THE INVENTION

1. Field of the Invention

The present invention relates to a joint configuration for joining metal tubes.

2. Description of the Related Art

Metal tubes are used in many industries to form supporting frames for various types of goods. Metal tubes commonly have a generally square or rectangular cross section. The thickness of the metal used to form the metal tube and the shape of the cross-section determines the strength of the metal tube.

There are several ways to join two or more metal tubes. For example, depending on the type of metal used to form the metal tubes, it may be possible to weld or braze the metal tubes together. Mechanical fasteners may also be used. However, in some circumstances, it would be advantageous to provide a joint configuration that would allow two or more metal tubes to be joined in a simple manner.

### SUMMARY OF THE INVENTION

A joint between two metal tubes may be formed by creating a cutout on each of the tubes, each cutout having a pair of channels sized according to a wall thickness of a tube to be received, and then pressing the tubes together. Teeth are formed in the channels to engage the wall of the opposite tube when the tubes are pressed together to prevent the joint from separating once created. Optionally a mechanical fastener may be used to further strengthen the joint structure.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a perspective view of an example frame assembled using the joint configuration according to an embodiment of the invention;

FIG. 2 is a cross-section of an example metal tube;

FIG. 3 shows an exploded view of an example channel formed in a tube and sized to receive a wall of an opposing tube according to an embodiment of the invention;

FIG. 4 shows an exploded view of the wall of the opposing tube received in the channel of FIG. 3;

FIGS. 5 and 6 show example channels having different teeth placements;

FIGS. 7A-7C are perspective views showing formation of a joint according to an embodiment of the invention in which two similarly sized tubes are joined in an X-configuration;

FIG. 8 is a partial cross-sectional view of the joint of FIG. 7C;

FIG. 9 is an exploded view of a tab structure that may be integrally formed with the tube and used to mechanically reinforce a joint formed according to an embodiment of the invention;

FIGS. 10A-10C are perspective views showing formation of a joint according to an embodiment of the invention in which two similarly sized tubes are joined in an T-configuration;

FIG. 11 is an exploded view of the end of the bar of FIG. 10A;

FIG. 12 is an exploded view of the portion of the bar of FIG. 10B where the joint with the bar of FIG. 10A will occur; and

FIG. 13 is a partial cross-sectional view of the joint of FIG. 10C.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, and dimensions, have not been described in detail so as not to obscure the invention.

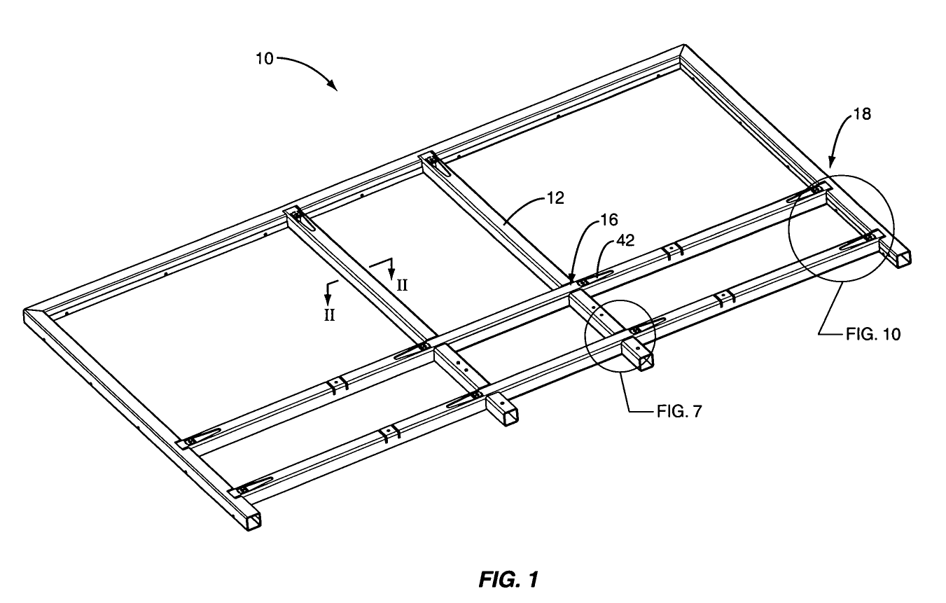

FIG. 1 shows a frame that has been assembled using the joint configuration described in greater detail below. As shown in FIG. 1, a frame 10 may be formed from metallic tubes 12. The tubes 12 in the illustrated embodiment are formed of metal and are generally square in cross-section. The tubes are hollow with walls defining a tubular structure. Metal tubes are commonplace and the invention is not limited to use with particular tubes. The joint structure described herein may be used with many different metallic tubes and the particular dimensions of the joint structure may be adjusted to take into account the shape of the tube cross-section and the thickness of the tube walls.

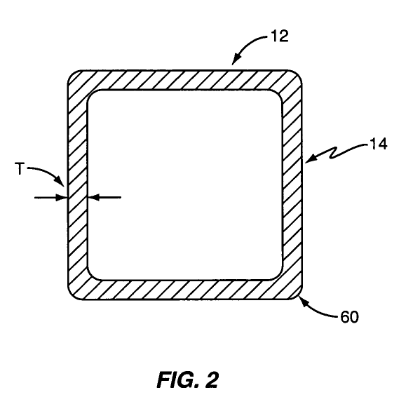

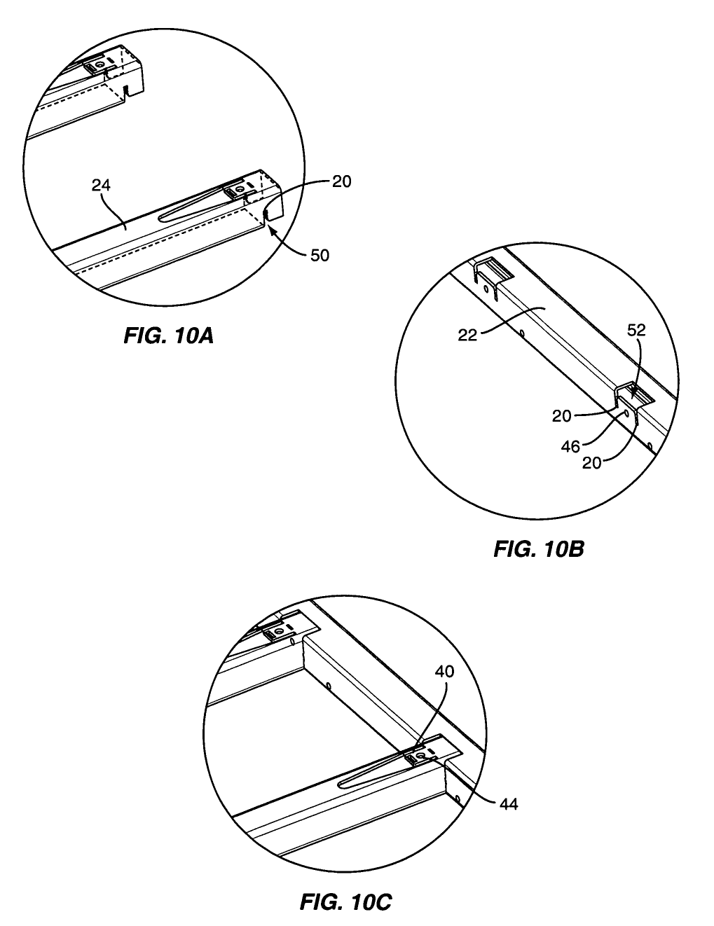

FIG. 2 shows a cross-section of an example metallic tube. As shown in FIG. 10, the tube 12 has an overall shape that is generally hollow, with an outer wall 14 of thickness T. Different tubes may be joined using the joint structure of the invention. For example, the joint structure may be used to join similarly shaped tubes or alternatively may be used to join tubes with different overall sizes or wall thicknesses.

Referring back to FIG. 1, the tubes may need to be joined together in an X configuration 16 in which each tube extends out from both sides of the joint. Additionally, the tubes may need to be joined together in a T configuration 18 in which one tube is butt joined to terminate at a mid point on another tube. The joint structure described in greater detail below may be used to join tubes in either of these configurations.

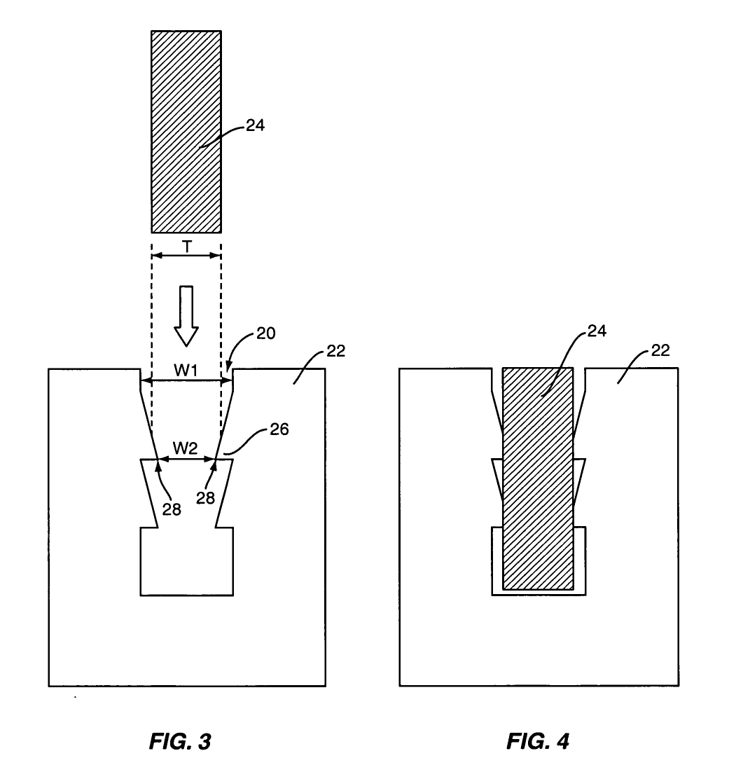

FIGS. 3 and 4 illustrate conceptually how the joint configuration operates to join two tubes. Only the operative portions of the joint are shown in these two figures; a more detailed configuration of how the joint may be configured to join two similarly sized tubes will be described below. As noted above, the invention is not limited to joining tubes of similar size as differently sized tubes may be joined together using the joint structure described herein as well. As shown in FIG. 3, a channel 20 is cut into a first metal tube 22. The channel 20 is sized to have a width W1 that is larger than the wall thickness T of a second metal tube 24 that is to be joined to the first metal tube.

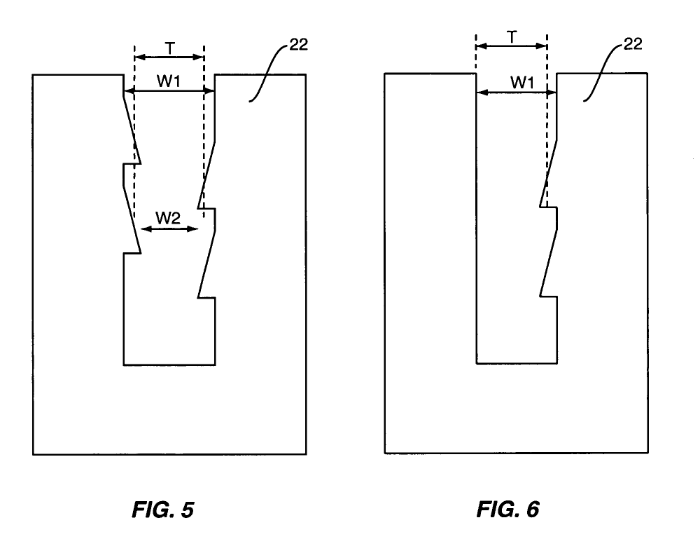

Teeth 26 are formed in the channel 20 and are sized such that teeth on opposite sides of the channel 20 have points 28 that are a distance W2 apart from each other. The teeth 26 may be formed on both sides of the channel 20 and spaced to be directly apart from each other as shown in FIGS. 3 and 4. Other configurations for the teeth may be implemented as well. For example, as shown in FIG. 5, the teeth may be arranged to be staggered within the channel or alternatively may be formed on only one side of the channel, as shown in FIG. 6.

In operation, the two tubes will be pressed together such that the wall tube 24 is pressed into the channel 20 formed in tube 22. (see FIG. 4). The teeth 26 on the inside of the channel will be deformed during the process of pressing the two tubes together, to bite into the tube 24. The pressure fit formed between the two tubes may be used to hold the tubes together thus forming a stable joint configuration between the two tubes. Optionally, depending on the configuration of the joint, it may be necessary to hammer the two tubes together to cause the tubes to be pressed into each other while forming the joint.

The widths W1 and W2 of the channel depend on the thickness of the wall of the tube that is to be pressed into the channel. As shown in FIGS. 3 and 4, the width W1 should be formed to be slightly larger than the wall thickness T so that the channel is able to accept the wall. The particular tolerance may depend on the size of the teeth, the thickness of the wall, and the shape of the teeth. The width W2 between the points 28 of the teeth 26 should be slightly smaller than the wall thickness T. The amount with which the width W2 should be smaller than the thickness T of the tube to be joined will depend on the material that is being used to form each of the tubes. For example, if the tube 22 is made of malleable aluminum, which deforms more easily, the teeth may be made slightly larger than if the tube 22 is made of hardened steel.

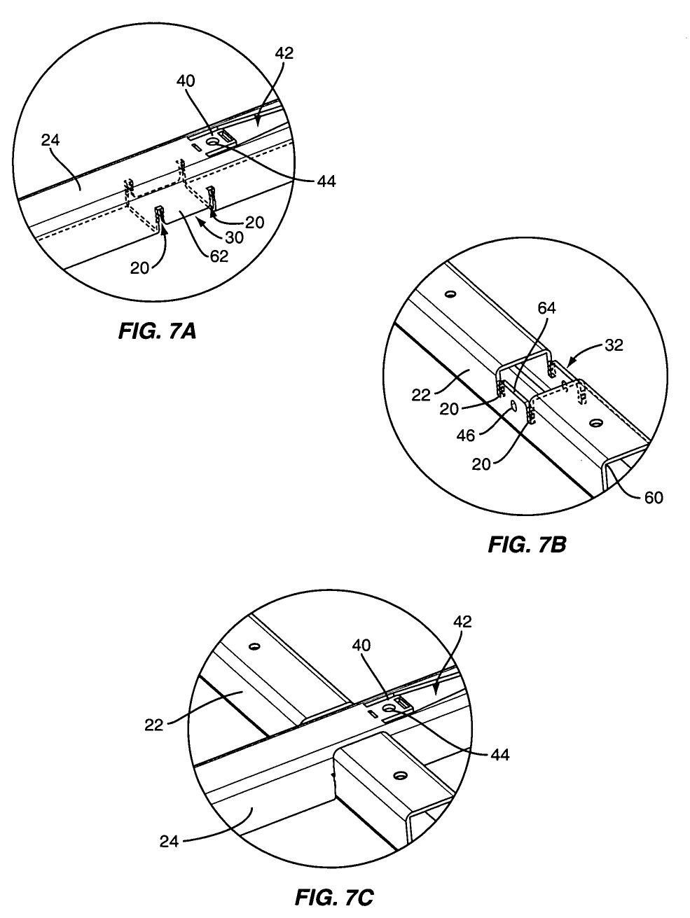

FIGS. 7A-7C show formation of a joint according to an embodiment of the invention in which two similarly sized tubes are joined in an X-configuration. As shown in FIG. 7A, a cutout 30 will be formed in the top tube 24 to remove material from the area of the top tube where the joint will occur. A similar cutout 32 will be formed in the bottom tube 22 to remove material from the area of the bottom tube where the joint will occur. The cutouts 30, 32 on the top and bottom tube will be sized such that the width of each cutout is the same as the width of the opposite tube. For example if the top tube 24 (shown in FIG. 7A) has an overall width of 2 inches, then the width of the cutout 32 in the bottom tube 22 will be 2 inches. The cutout may be slightly larger to provide tolerance in the joint. Similarly, if the bottom tube 22 (shown in FIG. 7B) has an overall width of 1.5 inches, then the width of the cutout 30 in the top tube 24 (shown in FIG. 7A) will be 1.5 inches (plus applicable tolerance).

By removing material from each of the top tube and the bottom tube, the two tubes are configured to receive each other as shown in FIG. 7C. Channels 20 are formed along the edge of each cutout 30, 32. Teeth are formed in each of the channels. The channels 20 are and positioned relative to each other such that when the top tube and bottom tube are pressed together the channels are positioned to receive the walls of the opposing tube. Specifically, as shown in FIG. 7A, four channels 20 are formed in tube 24 to receive the walls of tube 22. Likewise, as shown in FIG. 7B, four channels 20 are formed in tube 22 to receive the walls of tube 24.

Formation of the channels 20 causes extensions 62 to be defined in the top tube 24 and causes extensions 64 to be defined in the bottom tube 22. When the two tubes are pressed together, the extensions 62, 64 will extend into the inside of the other respective tube. In connection with this, the teeth in the 8 channels that have been formed on the two tubes will deform as described above in connection with FIGS. 3 and 4 to cause a secure joint to be formed. (FIG. 7C).

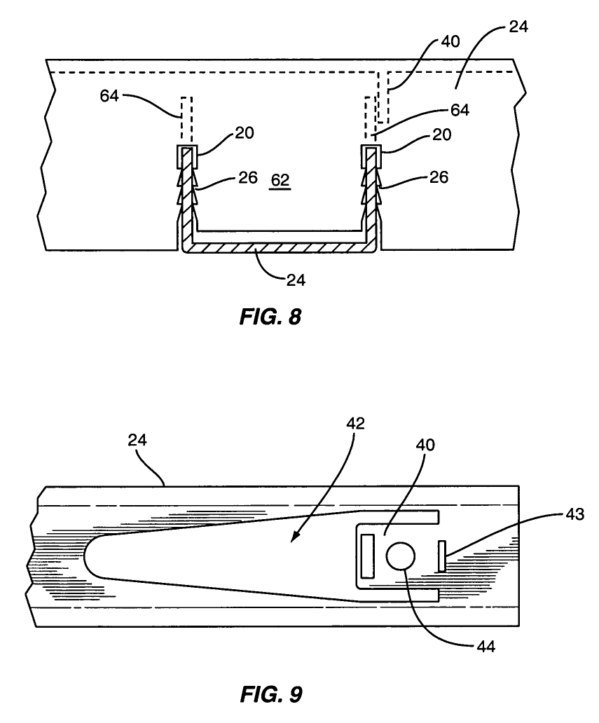

FIG. 8 shows a cutout of the X-joint of FIGS. 7A-7C in greater detail. As shown in FIG. 8, when material from the bottom tube 22 is removed to form the cutout region 32 and channels 20, two extensions 64 will be formed (one on either side of the tube). When the extensions 62 of the top tube are inserted into the cutout 32 of the lower tube 22, the extensions 64 of the bottom tube will similarly extend into the cutout 50 of the top tube. The extensions should be sized to not impinge on the interior surface of the mating tube when the walls of the tubes are fully situated within the channels 20. The teeth 26 in the channels 20 will grip the walls of the opposing tube to cause a firm joint to be created between the two tubes.

Although the joint formed in this manner may be sufficiently strong, depending on the application it may be desirable to further reinforce the joint with a mechanical fastener. Common mechanical fasteners include bolts, screws, and rivets. The invention is not limited to the use of any particular mechanical fastener.

In the embodiment shown in FIGS. 7A-7C, a tab 40 is formed in a cutout region 42. An aperture 44 is formed in the tab 40. FIG. 9 shows an enlarged view of the tab structure that may be used to mechanically reinforce the joint. If a mechanical fastener is desired to be used to strengthen the joint, the tab 40 may be bent down into the central area of the tube 24. Depending on the material being used to form the tube, an additional cutout 43 may be cut along the line where the bend is to occur to make it easier to bend the tab 40 into the central area of the tube.

The aperture 44 is positioned on the tab 40 to be adjacent an aperture 46 in the lower tube 22 once the two tubes have been joined together and the tab has been bent into the tube cavity. The mechanical fastener may then be inserted into the two apertures to mechanically join the two tubes together. Where a bolt is to be used, the aperture 46 may be pre-tapped so that threads are formed in the aperture 46. The bolt may then be inserted into aperture 44 and threaded into aperture 46 to form a mechanical reinforcing connection between the two tubes. Alternatively a self-tapping bolt or other mechanical fastener may be used to mechanically reinforce the joint. The cutout region 42 may be sized to allow tools to be inserted into the interior of the tube to allow the mechanical fastener to be tightened once inserted into the apertures 44, 46.

In the embodiment shown in FIGS. 7A-7C, the joint to be formed is an X-joint in which both tubes extend in both directions on either side of the joint. There are instances when it would be desirable to implement a T-shaped joint such that one of the tubes is butted into the other tube part of the way along its length. FIGS. 10A-10C show a T-shaped joint of this nature.

As shown in FIGS. 10A-10C, a cutout 50 will be formed in the top tube 24 to remove material from the end of the top tube that will be butted into the other tube where the joint will occur. A similar cutout 52 will be formed in the bottom tube 22 to remove material from the area of the bottom tube where the joint will occur. The cutouts 50, 52 on the top and bottom tube will be sized such that the width of each cutout is the same as the width of the opposite tube in a manner similar to that described above in connection with FIGS. 7A-7C. However, the cutout regions for the T-shaped joint only extend part of the distance across the tube rather than all the way across the tube as was the case in FIGS. 7A-7C. This allows the end of tube 24 to be received into the central area of the tube 22.

By removing material from each of the top tube 24 and the bottom tube 22, the two tubes are configured to receive each other as shown in FIG. 10C. Channels 20 are formed along the edge of each cutout 50, 52 so that when the top tube and bottom tube are pressed together the channels are positioned to receive the walls of the opposing tube. Specifically, as shown in FIG. 10A, two channels 20 are formed in tube 24 to receive the walls of tube 22. Likewise, as shown in FIG. 10B, two channels 20 are formed in tube 22 to receive the walls of tube 24. Teeth are formed in each of the channels. When the two tubes are pressed together, the teeth in the 4 channels will deform to cause a secure joint to be formed. (FIG. 10C). The joint may be mechanically reinforced if desired using tab 44 as described in greater detail above in connection with FIGS. 7A-7C.

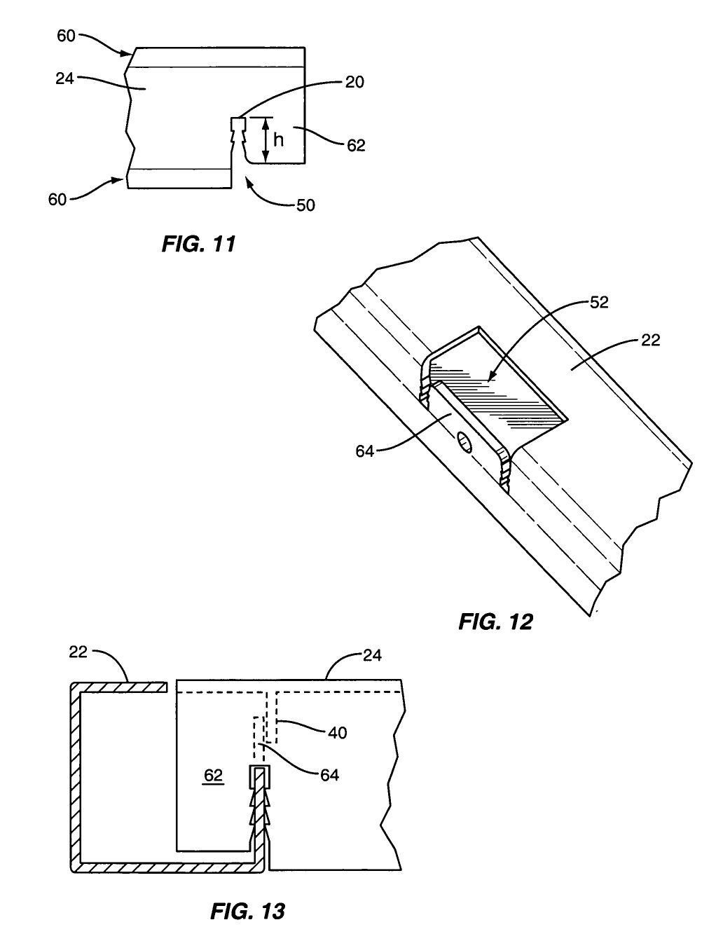

FIG. 11 shows the top tube cutout of FIG. 10A in greater detail, while FIG. 12 shows the bottom tube cutout of FIG. 10B in greater detail. FIG. 13 shows a cross-sectional view at the joint of the top and bottom tubes joined together. As shown in FIG. 12, when material from the bottom tube 22 is removed to form the cutout region 52 and channels 20, an extension 64 will be formed. As shown in FIG. 13, when the extension 64 on the top tube is inserted into the cutout 52 of the lower tube 22, the extension 64 will extend into the cutout 50 of the top tube. Tab 40 may then be bent down to allow a mechanical fastener to be used to further secure the joint.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A metal tube, comprising:
first walls defining a tube structure, the first walls having a first thickness;
a first cutout area defined in the first tube, the first cutout area being sized according to an outer dimension of a second tube to be joined with the first tube, the first cutout area having a first channel defined on one edge and a second channel defined on an opposite edge, each of the first and second channels being sized according to a second wall thickness of the second tube, the first and second channels further having teeth defined therein to engage the wall of the second tube if the first and second tubes are pressed together.

2. The metal tube of claim 1, wherein the first and second channels have widths larger than the second wall thickness.

3. The metal tube of claim 2, wherein the teeth have points that are disposed a second width apart, the second width being smaller than the second wall thickness, such that the points of the teeth will be deformed if the first and second tubes are pressed together.

4. The metal tube of claim 1, wherein the teeth are disposed on each side of each channel.

5. The metal tube of claim 4, wherein the teeth are staggered along the length of the channel.

6. The metal tube of claim 4, wherein the teeth are spaced along a length of the channel to be opposite each other on opposite walls of the channel.

7. The metal tube of claim 1, wherein the teeth are disposed on one side of the channel.

8. The metal tube of claim 1, wherein the cutout area extends across at least a part of a top surface of the first tube, and wherein the first and second channels are defined in at least a part of a front surface of the first tube.

9. The metal tube of claim 8, wherein the first cutout area extends all the way across the top surface of the first tube, and wherein the cutout area further comprises third and fourth channels defined on a back surface of the first tube.

10. The metal tube of claim 9, wherein the third and forth channels further having teeth defined therein to engage the wall of the second tube if the first and second tubes are pressed together.

11. A joint structure for joining a first tube having walls a first thickness with a second tube having second walls a second thickness; the joint structure comprising:
a first cutout area defined in the first tube, the first cutout area being sized according to an outer dimension of the second tube, the first cutout area having a first channel defined on one edge and a second channel defined on an opposite edge, each of the first and second channels being sized according to the second wall thickness of the second tube, the first and second channels further having teeth defined therein to engage the wall of the second tube if the first and second tubes are pressed together; and
a second cutout area defined in the second tube, the second cutout area being sized according to an outer dimension of the first tube, the second cutout area having a third channel defined on one edge and a fourth channel defined on an opposite edge, each of the third and fourth channels being sized according to the first wall thickness of the first tube, the third and fourth channels further having teeth defined therein to engage the wall of the first tube if the first and second tubes are pressed together.

12. The joint structure of claim 11, wherein the first cutout area extends across at least a part of a top surface of the first tube, and wherein the first and second channels are defined in at least a part of a front surface of the first tube; and
wherein the second cutout area is defined on a bottom surface of the second tube at an end of the second tube, and wherein the third and fourth channels are defined in sides of the second tube.

13. The joint structure of claim 12, wherein the first and second channels define an extension, and wherein an aperture is formed in the extension.

14. The joint structure of claim 13, wherein the second tube further comprises a tab depending from a surface opposite the second cutout area to be placed adjacent the extension of the first tube if the first and second tubes are pressed together.

15. The metal tube of claim 11, wherein the first cutout area extends all the way across the top surface of the first tube, wherein the first and second channels are defined in at least a part of a front surface of the first tube, and wherein the cutout area further comprises fifth and sixth channels defined on a back surface of the first tube; and
wherein the second cutout area is defined on a bottom surface of the second tube at a location in-between ends of the second tube, wherein the third and fourth channels are defined in sides of the second tube, and wherein the second cutout region further defines seventh and eighth channels in the sides of the second tube.

16. The joint structure of claim 15, wherein the first and second channels define an extension, and wherein an aperture is formed in the extension.

17. The joint structure of claim 16, wherein the second tube further comprises a tab depending from a surface opposite the second cutout area to be placed adjacent the extension of the first tube if the first and second tubes are pressed together.

18. The metal tube of claim 15, wherein each of the first through eight channels has teeth defined therein.
